(19) United States
(12) Patent Application Publication
(10) Pub. No.: US 2026/0119699 A1
(43) Pub. Date: Apr. 30, 2026

(54) DIFFERENTIAL PRIVACY USAGE BASED VEHICLE DATA ANALYSIS

(71) Applicant: Ford Global Technologies, LLC, Dearborn, MI (US)

(72) Inventor: David Michael Herman, West Bloomfield, MI (US)

(21) Appl. No.: 18/925,446

(22) Filed: Oct. 24, 2024

(51) Int. Cl. G06F 21/62; G06N 3/0455; G07C 5/00; G07C 5/08

(52) U.S. Cl. CPC G06F 21/6245; G06N 3/0455; G07C 5/008; G07C 5/0825

(57) ABSTRACT

Collecting and processing vehicle data with differential privacy is provided. A set of differential privacy settings are received by a telematics control unit (TCU) of a vehicle, corresponding to a user, the differential privacy settings defining which sets of one or more vehicle signals to be sent to a cloud server. The TCU captures a plurality of vehicle signals from a plurality of controllers and/or sensors of the vehicle. The TCU applies a filter to the vehicle signals according to the differential privacy settings to generate filtered signals. The filtered signals are encoded into sparse signals. The sparse signals are transmitted from the vehicle to the cloud server for processing by an analysis model to determine metrics for the vehicle according to the differential privacy settings of the user.

### TECHNICAL FIELD

Aspects of the disclosure generally relate to use of differential privacy settings for vehicle-based data analysis.

### BACKGROUND

Connected vehicles may send data to a cloud system. Usage-based insurance (UBI) is a type of vehicle insurance whereby the premium cost is dependent on the driving behavior of a driver. A UBI device may be connected to a vehicle network via a connector such as an on-board diagnostic II (OBD-II) port to collect vehicle operating data and send the data to a remote server for analysis. In other examples, a telematics control unit (TCU) of the vehicle may collect the vehicle operating data and send the data to the remote server for analysis.

An autoencoder is a type of artificial neural network used in unsupervised learning for data compression and feature extraction. An autoencoder includes of two main parts: an encoder that compresses the input data into a latent space representation, and a decoder that reconstructs the original data from this compressed form.

### SUMMARY

In one or more illustrative examples, a method for collecting and processing vehicle data with differential privacy includes receiving, by a controller of a vehicle, a set of differential privacy settings corresponding to a user of the vehicle, the differential privacy settings defining which sets of one or more vehicle signals to be sent to a cloud server; capturing, by the controller, a plurality of vehicle signals from a plurality of controllers and/or sensors of the vehicle; applying, by the controller, a filter to the vehicle signals according to the differential privacy settings to generate filtered signals; encoding the filtered signals into sparse signals; and transmitting the sparse signals from the vehicle to the cloud server for processing by an analysis model to determine metrics for the vehicle according to the differential privacy settings of the user.

In one or more illustrative examples, the encoding of the filtered signals into the sparse signals includes using a latent space model including an encoder and a decoder, such that the encoding of the filtered signals into the sparse signals is performed using the encoder as installed on the vehicle.

In one or more illustrative examples, encoding the filtered signals into the sparse signals includes performing principal component analysis to reduce dimensionality of the filtered signals by finding a subset of orthogonal components that capture variance in the filtered signals.

In one or more illustrative examples, the method further includes detecting presence of the user using the sensors of the vehicle; and filtering the vehicle signals according to the differential privacy settings corresponding to the user whose presence is detected.

In one or more illustrative examples, the differential privacy settings include parameters for noise addition, and the filter adds noise to the vehicle signals before encoding to enhance user privacy.

In one or more illustrative examples, the noise added by the filter is Gaussian noise, Laplace noise, or reduction in fidelity of the vehicle signals, and the amount of the noise is adjustable based on the differential privacy settings.

In one or more illustrative examples, the method further includes displaying, on a human-machine interface (HMI), a set of user-selectable signal controls, each control corresponding to a different set of the one or more vehicle signals; and updating the differential privacy settings based on selection received from the user of which of the sets of the one or more vehicle signals to share with the cloud server.

In one or more illustrative examples, the method further includes providing, on the HMI, an indication of which of the sets of the one or more vehicle signals correlate with the metrics generated by the analysis model to assist the user in selecting the one or more vehicle signals to share.

In one or more illustrative examples, the method further includes receiving a message indicating a request to update the set of user-selectable signal controls based on an analysis by the cloud server of contributions of the sets of the one or more vehicle signals to the metrics.

In one or more illustrative examples, the analysis model determines the metrics with respect to vehicle maintenance.

In one or more illustrative examples, the analysis model determines the metrics with respect to usage-based insurance.

In one or more illustrative examples, a system for using universal signals for determining vehicle metrics includes one or more computing devices of a cloud server including non-transitory storage and a processor, configured to receive, from a plurality of vehicles, sparse signals corresponding to vehicle data captured by sensors and/or controllers of the vehicles, the sparse signals being filtered according to differential privacy settings defining which sets of one or more vehicle signals to be sent to the cloud server; apply, by the cloud server, an analysis model to the sparse signals to generate vehicle metrics; analyze the vehicle metrics for contributions of the sets of one or more vehicle signals to the metrics; and send messages, to the vehicles, to update the sets of the one or more vehicle signals based on an analysis by the cloud server of contributions of the sets of the one or more vehicle signals to the metrics.

In one or more illustrative examples, the one or more computing devices are further configured to transmit, in response to client queries, the generated vehicle metrics to a metric server for access by insurance providers or vehicle service entities.

In one or more illustrative examples, the one or more computing devices are further configured to provide, on a HMI, a set of user-selectable signal controls, each control corresponding to a different set of the one or more vehicle signals; and update the differential privacy settings for a user based on selection received from the user of which of the sets of the one or more vehicle signals to share with the cloud server.

In one or more illustrative examples, the one or more computing devices are further configured to provide, on the HMI, an indication of which of the sets of the one or more vehicle signals correlate with the metrics generated by the analysis model to assist the user in selecting the one or more vehicle signals to share.

In one or more illustrative examples, the sparse signals are encoded, using a latent space model including an encoder and a decoder, by the encoder, and the one or more computing devices are further configured to apply the sparse signals to the analysis model without decoding the sparse signals using the decoder.

In one or more illustrative examples, the sparse signals are encoded by performing principal component analysis to reduce dimensionality of the vehicle data by finding a subset of orthogonal components that capture variance in the vehicle data.

In one or more illustrative examples, a vehicle for collecting and processing vehicle data with differential privacy includes one or more sensors and/or controllers; and a processing controller, in communication with the one or more sensors and/or controller, configured to: receive a set of differential privacy settings corresponding to a user of the vehicle, the differential privacy settings defining which sets of one or more vehicle signals to be sent to a cloud server, capture a plurality of vehicle signals from the one or more sensors and/or controllers, detect presence of the user using the one or more sensors and/or controllers, apply a filter to the vehicle signals, according to the differential privacy settings corresponding to the user whose presence is detected, to generate filtered signals, encode, using a latent space model including an encoder and a decoder, by the encoder as installed on the vehicle, the filtered signals into sparse signals, and transmit the sparse signals from the vehicle to the cloud server for processing by an analysis model to determine metrics for the vehicle according to the differential privacy settings of the user.

In one or more illustrative examples, the differential privacy settings include parameters for noise addition, and the filter adds noise to the vehicle signals before encoding to enhance user privacy.

In one or more illustrative examples, the noise added by the filter is Gaussian noise, Laplace noise, or reduction in fidelity of the vehicle signals, and the amount of the noise is adjustable based on the differential privacy settings.

In one or more illustrative examples, the processing controller is further configured to display, on an HMI, a set of user-selectable signal controls, each control corresponding to a different set of the one or more vehicle signals; and update the differential privacy settings based on selection received from the user of which of the sets of the one or more vehicle signals to share with the cloud server.

In one or more illustrative examples, the processing controller is further configured to provide, on the HMI, an indication of which of the sets of the one or more vehicle signals correlate with the metrics generated by the analysis model to assist the user in selecting the one or more vehicle signals to share.

In one or more illustrative examples, the processing controller is further configured to receive a message indicating a request to update the set of user-selectable signal controls based on an analysis by the cloud server of contributions of the sets of the one or more vehicle signals to the metrics.

### BRIEF DESCRIPTION OF THE DRAWINGS

FIG. 1 illustrates an example system for using an autoencoder and user-specific settings for performing differential privacy;

FIG. 2 illustrates an example autoencoder architecture for use in the system of FIG. 1;

FIG. 3 illustrates an example data flow for the operation of the system of FIG. 1;

FIG. 4 illustrates an example of the human-machine interface (HMI) for configuring the differential settings;

FIG. 5 illustrates an example process for implementing the use of the differential settings in data collection by the vehicles;

FIG. 6 illustrates an example process for implementing the analysis of sparse signals by the cloud server; and

FIG. 7 illustrates an example computing device for using an autoencoder and user-specific settings for performing differential privacy.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Aspects of the disclosure provide an approach that incorporates differential privacy into the collection and analysis of data for usage-based insurance (UBI). The approach utilizes differential privacy settings where each vehicle identification numbers (VINs) enrolled in the data collection plan is assigned specific privacy settings, allowing for customizable privacy protection based on individual preferences. The approach may also utilize a latent space model, such as a variational autoencoder (VAE) for encoding and decoding data, enabling efficient and accurate analysis while maintaining privacy. In some examples, the settings may be further based on local regulations and/or on capabilities of the vehicle.

By implementing differential privacy at the core of the data collection process, the approach ensures that individual VINs have varying levels of privacy settings, safeguarding the sensitive information of vehicle owners. Varying levels of privacy may be based on customer selection of insurance offerings that may carry varying prices. In some examples, the customer selections may affect rates or other aspects of the offering. In some examples, the model itself may be used to suggest which customer selections to choose to balance privacy and the best results. Further aspects of the disclosure are discussed in detail herein.

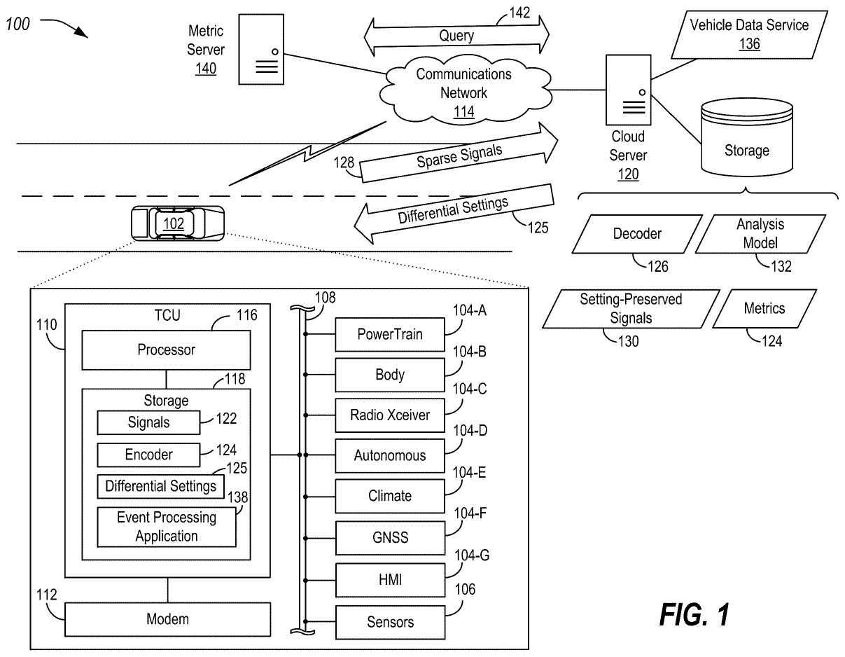

FIG. 1 illustrates an example system 100 for using an autoencoder and user-specific settings for performing differential privacy. The system 100 includes one or more vehicles 102, where each vehicle 102 includes a plurality of controllers 104 and sensors 106. Each vehicle 102 also includes one or more vehicle buses 108 for communication between the controller 104, sensors 106, and a telematics control unit (TCU) 110. The TCU 110 includes or otherwise has access to a modem 112 configured to facilitate communication over a communication network 114. The TCU 110 may include a processor 116 and a storage 118. The TCU 110 may capture signals 122 and maintain them in the storage 118. The storage 118 may also maintain an event processing application 138 and an encoder 124. The event processing application 138 may use the encoder 124 to encode the signals 122 into sparse signals 128 using differential settings 125 and may send the sparse signals 128 to a cloud server 120. The cloud server 120 may also be configured to execute a vehicle data service 136 that uses one or more analysis models 132 to operate on the sparse signals 128 to determine various metrics 134. The metrics 134 may also be provided to a metric server 140 responsive to client queries 142, in an example, to facilitate quoting insurance rates for the vehicles 102 and/or for scheduling maintenance for the vehicles 102. It should be noted that the system 100 is only an example, and systems 100 with more, fewer, or different components may be used. As one possibility, one or more one or more analysis models 132 may be run on the vehicle 102, with such metrics 134 being provided to the cloud server 120 and/or to the metric server 140. As another possibility, the operations being disclosed as being performed by the TCU 110 may in whole or in part be performed by one or more other processing controllers, such as by a gateway controller operating as an intermediary facilitating communications between the other controllers 104.

The vehicle 102 may be any various types of automobile, crossover utility vehicle (CUV), sport utility vehicle (SUV), truck, recreational vehicle, boat, plane or other mobile machine for transporting people or goods. Such vehicles 102 may be human-driven or autonomous. In many cases, the vehicle 102 may be powered by an engine. As another possibility, the vehicle 102 may be a battery electric vehicle (BEV) powered by one or more electric motors. As a further possibility, the vehicle 102 may be a hybrid electric vehicle (HEV) powered by both an engine and one or more electric motors, such as a series hybrid electric vehicle (SHEV), a parallel hybrid electrical vehicle (PHEV), or a parallel/series hybrid electric vehicle (PSHEV). Alternatively, the vehicle 102 may be an autonomous vehicle (AV). The level of automation may vary between variant levels of driver assistance technology to a fully automatic, driverless vehicle. As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. For title, inventory, and other purposes, vehicles 102 may be associated with unique identifiers, such as VINs. It should be noted that while automotive vehicles 102 are being used as examples of traffic participants, other types of traffic participants may additionally or alternately be used, such as bicycles, scooters, and pedestrians.

The vehicle 102 may include a plurality of controllers 104 configured to perform and manage various vehicle 102 functions under the power of the vehicle battery and/or drivetrain. As depicted, the example vehicle controllers 104 are represented as discrete controllers 104 (i.e., controllers 104A through 104G). However, the vehicle controllers 104 may share physical hardware, firmware, and/or software, such that the functionality from multiple controllers 104 may be integrated into a single controller 104, and that the functionality of various such controllers 104 may be distributed across a plurality of controllers 104.

As some non-limiting vehicle controller 104 examples: a powertrain controller 104A may be configured to provide control of engine operating components (e.g., idle control components, fuel delivery components, emissions control components, etc.) and for monitoring status of such engine operating components (e.g., status of engine codes); a body controller 104B may be configured to manage various power control functions such as exterior lighting, interior lighting, keyless entry, remote start, and point of access status verification (e.g., closure status of the hood, doors and/or trunk of the vehicle 102); a radio transceiver controller 104C may be configured to communicate with key fobs, mobile devices, or other local vehicle 102 devices; an autonomous controller 104D may be configured to provide commands to control the powertrain, steering, or other aspects of the vehicle 102; a climate control management controller 104E may be configured to provide control of heating and cooling system components (e.g., compressor clutch, blower fan, temperature sensors, etc.); a global navigation satellite system (GNSS) controller 104F may be configured to provide vehicle location information; and a HMI controller 104G may be configured to receive user input via various buttons or other controls, as well as provide vehicle status information to a driver, such as fuel level information, engine operating temperature information, and current location of the vehicle 102.

The controllers 104 of the vehicle 102 may make use of various sensors 106 in order to receive information with respect to the surroundings of the vehicle 102. In an example, these sensors 106 may include one or more of cameras (e.g., advanced driver-assistance system (ADAS) cameras), ultrasonic sensors, radar systems, and/or lidar systems.

One or more vehicle buses 108 may include various methods of communication available between the vehicle controllers 104, as well as between the TCU 110 and the vehicle controllers 104. As some non-limiting examples, the vehicle bus 108 may include one or more of a vehicle controller area network (CAN), an Ethernet network, and a media-oriented system transfer (MOST) network.

The TCU 110 may include network hardware configured to facilitate communication between the vehicle controllers 104 and with other devices of the system 100. For example, the TCU 110 may include or otherwise access a modem 112 configured to facilitate communication over a communication network 114. The TCU 110 may, accordingly, be configured to communicate over various protocols, such as with the communication network 114 over a network protocol (such as Uu). The TCU 110 may, additionally, be configured to communicate over a broadcast peer-to-peer protocol (such as PC5), to facilitate cellular vehicle-to-everything (C-V2X) communications with devices such as other vehicles 102. It should be noted that these protocols are merely examples, and different peer-to-peer and/or cellular technologies may be used.

The TCU 110 may include various types of computing apparatus in support of performance of the functions of the TCU 110 described herein. In an example, the TCU 110 may include one or more processors 116 configured to execute computer instructions, and a storage 118 medium on which the computer-executable instructions and/or data may be maintained. A computer-readable storage medium (also referred to as a processor-readable medium or storage 118) includes any non-transitory (e.g., tangible) medium that participates in providing data (e.g., instructions) that may be read by a computer (e.g., by the processor(s) 116). In general, the processor 116 receives instructions and/or data, e.g., from the storage 118, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C #, Fortran, Pascal, Visual Basic, Python, Java Script, Perl, etc.

The TCU 110 may be configured to include one or more interfaces from which information of the vehicle 102 may be sent and received. This information can be sensed, recorded, and sent to one or more cloud servers 120. In an example, similar to the TCU 110, the cloud server 120 may also include one or more processors (not shown) configured to execute computer instructions, and a storage medium (not shown) on which the computer-executable instructions and/or data may be maintained.

The TCU 110 may be configured to facilitate the collection of vehicle signals 122 from the vehicle controllers 104 connected to the one or more vehicle buses 108. These may include, for example, ADAS signals generated by ADAS functions of the vehicle 102. While only a single vehicle bus 108 is illustrated, it should be noted that in many examples, multiple vehicle buses 108 are included, usually with a subset of the controllers 104 connected to each vehicle bus 108. Accordingly, to access a given controller 104, the TCU 110 may be configured to maintain a mapping of which vehicle buses 108 are connected to which controllers 104, and to access the corresponding vehicle bus 108 for a controller 104 when communication with that particular controller 104 is desired.

As used herein, vehicle signals 122 (e.g., ADAS signals and the like) may refer to various binary, multi-state, integer, float, and/or continuous parameters that may be generated or otherwise raised by the vehicle controller 104 and/or sensors 106. The signals 122 may include varying unit types, such as time series data of differing frequency and event streams, and/or differing object types such as float, array, matrices, nested data types, etc. As some non-limiting examples, the vehicle signals 122 may include one or more of: latitude, longitude, time, heading angle, speed, throttle position, brake status, steering angle, headlight status, wiper status, external temperature, turn signal status, ambient temperature or other weather conditions, alertness status, hands-off-wheel status, all-wheel drive (AWD) engaged status, front object detection, side object detection status, rear object detection status, etc.

The signals 122 present on the vehicle 102 may vary based on the software and hardware versions of the controllers 104 and/or sensors 106 of the vehicle 102. Moreover, different users of the vehicle 102 may have different preferences with respect to which of the signals 122 are shared with the cloud server 120. Thus, the vehicle 102 may receive and maintain differential settings 125 that include parameters such as privacy budget, noise addition mechanisms, and data aggregation techniques to ensure individual data points in the signals 122 remain confidential and/or otherwise reflect the user's preferences. Each vehicle 102 enrolled (e.g., according to VIN) in a data collection plan with the cloud server 120 may be assigned a unique set of differential settings 125 based on the user's preferences and privacy requirements.

A simple approach may be to simply remove specific input signals 122 associated with personally identifiable information (PII) data from data collection. However, that approach may provide limited data for performing predictions of the metrics 134. To better account for the differential settings 125, the TCU 110 and cloud server 120 may collectively use an autoencoder architecture.

An autoencoder is a type of neural network designed to learn efficient, compressed representations of input data in an unsupervised manner. For example, the autoencoder may be trained to capture the most important features of the signals 122 in a way that allows the signals 122 to be accurately reconstructed from a compressed representation. This could be used for various purposes such as de-noising, privacy enhancing, sparse data reconstruction, data space translation (specific to universal), etc. To do so, the autoencoder includes to two main components: the encoder 124 and a decoder 126. It should be noted that this is only an example embodiment, but other embodiments may be possible. As some other possibilities, a variant of an autoencoder may be used, such as a variational, adversarial, denoising, stacked, conditional, and/or multi-modal neural network. In other examples, other architectures may be used, such as a transformer network, statistical machine translation, or even a recurrent neural network (RNN) with an attention mechanism.

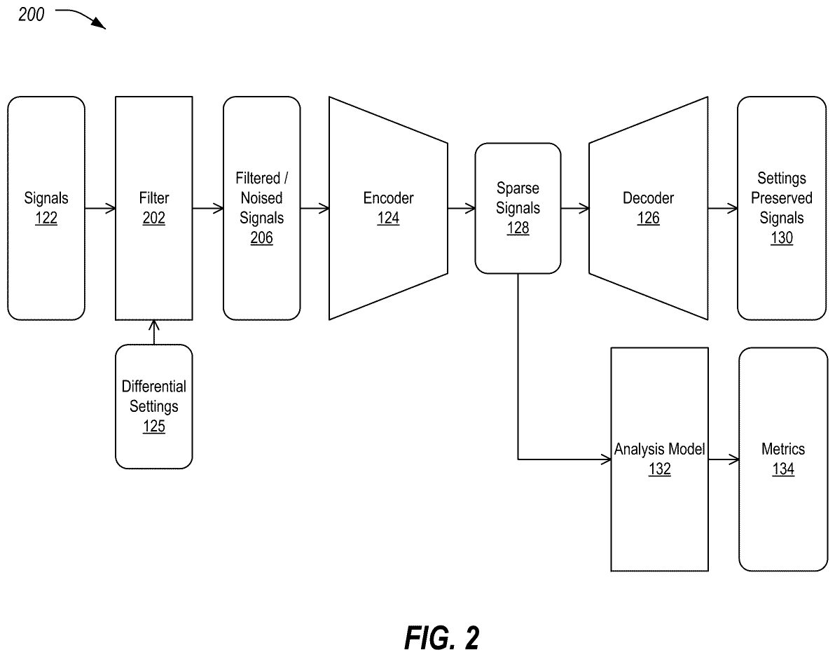

FIG. 2 illustrates an example autoencoder architecture 200 for use in the system 100. As shown in FIG. 2, and with continuing reference to FIG. 1, the signals 122 are received as an input to the autoencoder architecture 200. The signals 122 may be processed by a filter 202 using a user's differential settings 125 to generate filtered signals 206, which may then be applied to the encoder 124. The encoder 124 may be installed to the vehicle 102 and may convert a representation of the filtered signals 206 into sparse signals 128. The sparse signals 128 may be transmitted by the vehicle 102 to the cloud server 120. If desired, the sparse signals 128 may be converted into settings-preserved signals 130 by a decoder 126 corresponding to the encoder 124. The sparse signals 128 may also be processed by one or more analysis models 132 on the cloud server 120 to generate metrics 134.

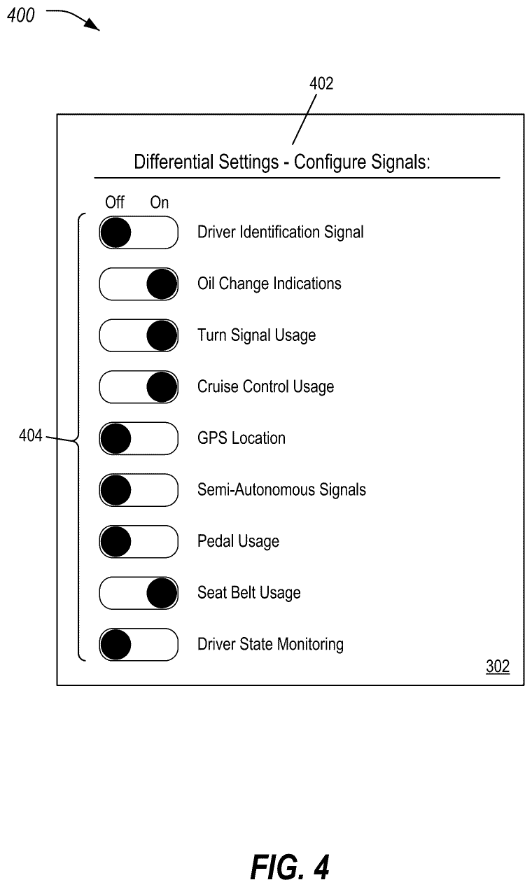

The filter 202 may be configured to remove information from the signals 122 as desired by the user of the vehicle 102. In an example, one user may opt into allowing all signals 122 of the vehicle 102 to be used by the cloud server 120 for processing. In another example, another user may opt into allowing only a subset of the signals 122 to be used. For instance, one user may prefer to allow the user of signals 122 such as steering wheel input, speed, lane, etc., while another use may prefer to avoid use of some of those signals 122, such as providing speed but not steering wheel input (further details of the configuration of the differential settings 125 are discussed with respect to FIG. 4). It should be noted that, in some examples, the differential settings 125 may be used by a recipient of the signals 122 to distinguish between a signal 122 that is selected as being unavailable as compared to a signal 122 that is unavailable due to a hardware issue on the vehicle 102.

The filter 202 may also be configured to add noise to the signals 122 as a further approach for maintaining user privacy. For example, noise can be introduced by use of Gaussian noise, Laplace noise addition, or simply reducing the fidelity and/or frequency of the signals 122 associated with the user. This may be used for various signals, such as location, speed, etc.

It should be noted that the filter 202 may also perform other filtering operations as a signal level filter (e.g. a Kalman filter, a particle filter), and/or produce a sensor fusion output. One or more of these operations may be optional and user configurable as well. These preferences of the user may be stored to the vehicle 102 in the differential settings 125, which may be applied to the signals 122 by the filter 202 to generate the filtered signals 206.

The encoder 124 is a neural network that receives the filtered signals 206 and compresses them into a smaller, lower-dimensional representation, referred to as a latent space. This latent space captures the essential features of the filtered signals 206 while discarding less important information, allowing for a more compact representation. The output of the encoder 124 is referred to herein as the sparse signals 128.

The decoder 126 is another neural network that takes the latent representation from the encoder 124 (e.g., the sparse signals 128) and attempts to reconstruct the original signals 122 from the sparse signals 128. The decoder 126 reverses the encoding process, expanding the compressed latent space back into the original data's dimensions.

A training process may be performed for the autoencoder to minimize difference between the original signals 122 input to the encoder 124 and the settings-preserved signals 130 output from the decoder 126. This may be accomplished using a loss function such as mean squared error or another suitable function (such as a domain-specific loss function). Thus, the autoencoder may learn to compress data into a smaller form that can later be reconstructed with minimal loss of information. Moreover, the autoencoder may also perform denoising of the signals 122 to address potentially corrupted data by learning to reconstruct a clean version of the data from its noisy version. A monitoring of a denoising autoencoder loss metric may also serve as a sanity check on the autoencoder translation, either in the training process or potentially on-vehicle. In addition, latent output of the encoder 124 or the output of the decoder 126 may be used for purposes of the metric 134 calculations.

Referring back to FIG. 1, the analysis model 132 may be any of various machine learning models trained to determine metrics 134 based on the signals 122 (here the sparse signals 128). In an example, an analysis model 132 may be configured to infer metrics 134 relates to vehicle 102 based on a training of the analysis model 132 using sparse signals 128 from vehicles 102 with known outcomes. In one example, an analysis model 132 may be trained on maintenance data for vehicles 102 based on sparse signal 128 data to allow the analysis model 132 to determine metrics 134 with respect to likely maintenance required by the vehicle 102. In another example, an analysis model 132 may be trained on insurance data for vehicles 102 based on sparse signal 128 data to allow the analysis model 132 to determine metrics 134 with respect to likely incidents that may occur due to how the vehicle 102 is being driven.

The system 100 may further include one or more metric servers 140 configured to access the cloud server 120 over the communication network 114. Using the services of the vehicle data service 136 of the cloud server 120, the one or more metric servers 140 may be configured to perform client queries 142 for the metrics 134 for various information, e.g., for preparation of insurance quotes for the vehicles 102 and/or for scheduling maintenance of the vehicles 102.

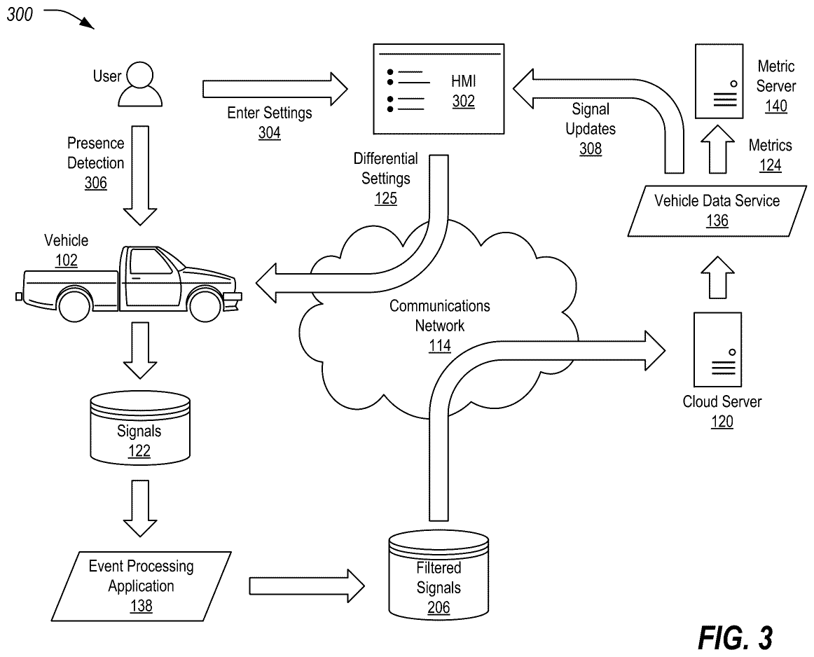

FIG. 3 illustrates an example data flow 300 for the operation of the system 100. As shown, a HMI 302 provides a user with an ability to interact with the configure the differential settings 125. Through this interface, the user can enter settings 304 to update their privacy preferences, configuring how much and what kind of signals 122 may be shared and processed by the system 100. With these differential settings 125 entered, the vehicle 102 may utilize its sensors 106 to detect presence of the user in or around the vehicle 102 using presence detection 306, ensuring that the differential settings 125 that are applied correspond to the user. Any changes made by the system 100 to the signals 122 are transmitted to the HMI 302, ensuring that the data collection and privacy measures are always aligned with the differential settings 125 of the user and the available signals 122.

The user represents an entity, such as an individual, a driver, an owner, a fleet manager, etc., who interacts with the vehicle 102. This entity has control over the differential settings 125 related to the collection of signals 122 from the vehicle 102, enabling the user to customize the level of differential privacy applied to the signals 122.

The HMI 302 refers to the interface that allows the user to interact with the system 100. The HMI 302 may be implemented as a dashboard, touchscreen, or any other user interface in the vehicle 102. In another example, the HMI 302 may be implemented as an app installed to a mobile device (such as a smartphone) of the user. In yet another example, the HMI 302 may be implemented as a web interface (e.g., hosted by the cloud server 120) and accessible via a web browser executed by a user device.

Regardless of implementation, the HMI 302 may provide an interface into which the user can enter settings 304 and/or update their differential settings 125, view the system 100 status, view metrics 134, and/or otherwise adjust and view other features of the system 100.

The differential settings 125 may be provided by the HMI 302 to the vehicle 102. In a fleet example, the differential settings 125 may be sent from the HMI 302 over the communication networks 114 to the vehicles 102 of the fleet being managed. In a user example, the differential settings 125 may be sent from the HMI 302 to the vehicles 102 associated with the user account being configured by the HMIs 302. The differential settings 125 may be received, e.g., using the TCU 110 of the vehicle 102, and may be maintained to the storage 118 of the vehicle 102.

The vehicle 102 may also be configured to utilize presence detection 306 to identify which user or users are present in or in proximity to the vehicle 102. In an example, the presence detection 306 may utilize one or more sensors 106 of the vehicle 102, such as cameras, to identify the presence of the user. In another example, the vehicle 102 may utilize wireless signals of a device of the user to identify the presence of the user (such as use of a phone-as-a-key device or a key fob of the user).

The event processing application 138 uses the filter 202 to create the filtered signals 206 from the signals 122 using the differential settings 125 for the detected user. These sparse signals 128 are then sent using the TCU 110 over the communication network 114 to the cloud server 120.

The cloud server 120 utilizes the vehicle data service 136 to generate metrics 134 using the sparse signals 128. In an example, the vehicle data service 136 may utilize one or more analysis models 132. For instance, metrics 134 related to insurance may be generated using an insurance analysis model 132, and/or metrics 134 related to maintenance may be generated using a maintenance analysis model 132. As the metrics 134 are determined using the sparse signals 128 based on the filtered signals 206, fidelity of the inputs to the analysis models 132 is ensured while also respecting the differential settings 125 of the detected user.

In some cases, the metrics 134 may indicate that there are changes in the sparse signals 128. For instance, based on identified trends, anomalies, or areas of improvement, the vehicle data service 136 may adjust its data gathering strategies, focusing on the most relevant sensors 106, signals 122, or conditions to improve future data quality and relevance. If so, these signal updates 308 may be provided to the HMI 302 to allow the user to update the differential settings 125 for the new signals 122.

FIG. 4 illustrates an example 400 of the HMI 302 for configuring the differential settings 125. In the example 400, the HMI 302 provides a title 402 indicating that the HMI 302 is for configuring the differential settings 125. The HMI 302 also illustrates a set of signal controls 404 for list of signals 122 or sets of signals that may be selected or deselected for use by the analysis models 132 of the vehicle data service 136.

For example, the signal control 404 may include one or more of: a signal control 404 for selecting the use of a driver identification signal 122, a signal control 404 for selecting the use of an oil change indication, a signal control 404 for selecting the use of turn signal usage, a signal control 404 for selecting the use of cruise control, a signal control 404 for selecting the use of location signals 122 indicative of the location of the vehicle 102, a signal control 404 for selecting the use of semi-autonomous driving signals 122, a signal control 404 for selecting the use of pedal usage signals 122, a signal control 404 for selecting the use of seat belt usage signals 122, and/or a signal control 404 for selecting the use of driver state monitoring signals 122. It should be noted that these are only examples, and more, fewer, and different signals 122 and/or sets or categories of signals 122 may be used with the signal controls 404.

In some examples, additional information may be provided with respect to the signals 122 that are selectable using the signal controls 404. For instance, the HMI 302 may provide indications of which signals are considered to correlate well with the metrics 134 for a given analysis model 132. In an example, signals 122 that are predefined as correlating will with results metrics 134 generated by the analysis model 132 may be provided with an indication showing that importance (e.g., next to the selector portion of the respective signal control 404). Notably, these signal 122 may differ for different analysis models 132. Such a feature may allow a use to better gauge whether it is useful to the user to allow that information to be provided to the vehicle data service 136.

As another example, the HMI 302 may provide information with respect to the expected privacy effect of allowing certain signals 122 to be used. This may be shown in addition to the information with respect to which signals 122 are useful for the analysis model 132, allowing the user to balance those two aspects. In some examples, if discounts are made available to the user, such as a good driving discount, the signals 122 that may be useful to allow the user to be eligible to receive those discounts may also be shown in the HMI 302. For instance, an icon indicating that a discount may be available may be shown next to the signal controls 404 that engage those signals 122.

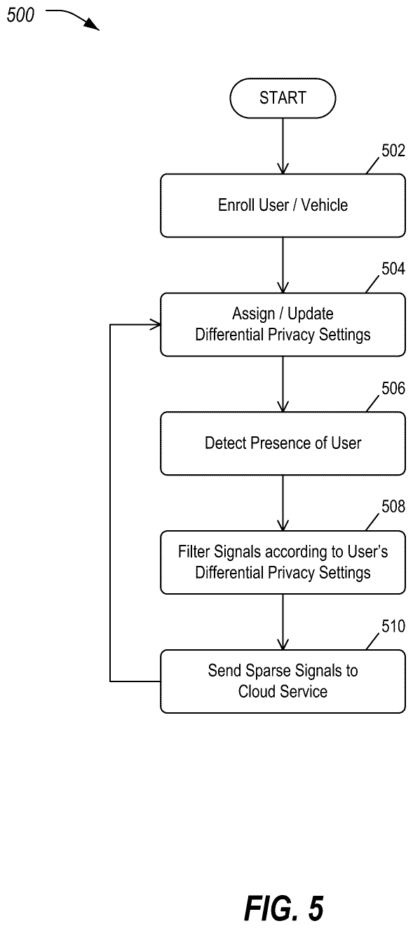

FIG. 5 illustrates an example process 500 for implementing the use of the differential settings 125 in data collection by the vehicles 102. In an example, the process 500 may be performed by the vehicles 102 in communication with the cloud server 120 over the communication network 114.

At operation 502, the user and/or the vehicle 102 enrolls with the cloud server 120. In an example, the user may provide his or her biometrics, phone identifier, or other identifiable information to the cloud server 120. This information may be used by the vehicle 102 (or vehicles 102 if a fleet) to identify the presence of the user.

At operation 504, the vehicle 102 receives differential setting 125 to be used for supplying the filtered signals 206 from the vehicle 102 to the cloud server 120. In an example, the user may access the HMI 302 to input his or her preferences for collection of signals 122. As shown in FIG. 3, the TCU 110 of the vehicles 102 may receive the differential settings 125 over the communication network 114 from the HMI 302. Or, if the HMI 302 is provided by the vehicle 102 itself, then the differential settings 125 may be stored to the vehicle 102 (and also optionally sent to the cloud server 120 for storage). Changes to the differential settings 125 made from a device other than the vehicle 102 may also be synced back to the vehicles 102 from the cloud server 120. The sending of signals 122 to the cloud server 120 from the vehicle 102 may accordingly require the user to opt into the data collection and use of the analysis model 132. An example HMI 302 is shown in FIG. 4. In another example, updated settings may be received to the vehicle 102 from the cloud server 120, e.g., based on changes in the signals 122 that are desired for use by the analysis models 132.

At operation 506, the vehicle 102 performs presence detection 306 to detect the presence of the user. In a simple example, the presence detection 306 may utilize one or more sensors 106 of the vehicle 102, such as cameras, to identify the presence of a driver. In another example, the vehicle 102 may utilize wireless signals of a device of the user to identify the presence of the driver (such as use of a phone-as-a-key device or a key fob of the driver). Based on the detection of presence of a driver, the vehicle 102 may activate the differential setting 125 of the vehicle 102 use in processing the signals 122 from the controllers 104 and/or sensors 106 of the vehicle 102.

In another example, the presence detection 306 may utilize the one or more sensors 106 of the vehicle 102, such as cameras or fobs, to identify the presence of a specific user. In another example, the vehicle 102 may utilize wireless signals of a device of the user to identify the presence of the user (such as use of a phone-as-a-key device or a key fob of the specific user). Based on the detection of the user, the vehicle 102 may activate the differential setting 125 of the user for use in processing the signals 122 from the controllers 104 and/or sensors 106 of the vehicle 102.

At operation 508, the vehicle 102 transforms signals 122 into sparse signals 128 according to the differential settings 125. For example, the signals 122 are collected from the various sensors 106 and controllers 104 of the vehicle 102, including cameras, light detection and ranging (LIDAR), radio detection and ranging (RADAR), and other relevant inputs. The other relevant inputs may also include processed signals, such as sensor fusions, time until the vehicle 102 reaches a detected object etc. This data is rich with information on the vehicle 102 environment, performance, and driver behavior, forming the foundation for the subsequent operations. As the signals 122 are gathered, the signals 122 may be normalized to ensure consistency and reliability across different sensor types and software versions, making it ready for further processing. Once captured, the signals 122 are processed by the filter 202 according to the differential settings 125 to only provide the information that the user desires to be provided. In some examples, the filter 202 may additionally add noise to the signals 122 to increase the privacy of the data collection. In an example, the filtered signals 206 may then be provided to an encoder 124 of the autoencoder architecture 200 to produce the sparse signals 128. An example approach to filtering and transforming the signal 122 into the sparse signal 128 is shown in detail in FIG. 2. In another example, encoding the filtered signals 206 into sparse signals 128 includes performing principal component analysis to reduces dimensionality of the filtered signals 206 by finding a subset of orthogonal components that capture variance in the filtered signals 206.

At operation 510, the vehicle 102 sends the sparse signals 128 to the cloud server 120. In an example, as shown in FIG. 3, the TCU 110 of the vehicles 102 may send the sparse signals 128 over the communication network 114 to the cloud server 120. After operation 510, control proceeds to operation 504 to determine whether updated differential settings 125 are available.

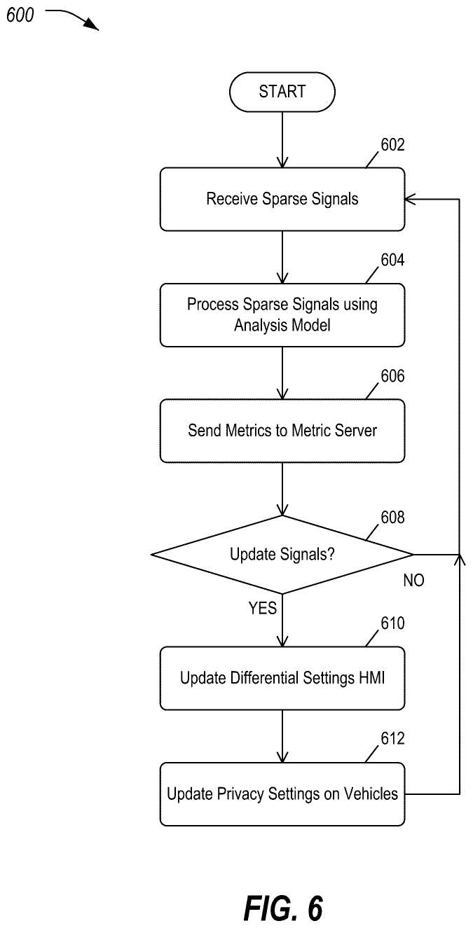

FIG. 6 illustrates an example process 600 for implementing the analysis of the sparse signals 128 by the cloud server 120. In an example, the process 600 may be performed by the cloud server 120 in communication with the vehicles 102 over the communication network 114.

At operation 602, the cloud server 120 receives sparse signals 128. For example, the sparse signals 128 may be received as sent at operation 510.

At operation 604, the cloud server 120 processes the sparse signals 128 using one or more analysis models 132. For instance, the sparse signals 128 generated by the autoencoder are utilized to produce the metrics 134 by the analysis models 132. The analysis model 132 may interpret the features of the sparse signals 128 to generates insights into vehicle wear, driver behavior, and/or other applications. By using the sparse signals 128 generated based off the differential settings 125, the system 100 ensures the privacy of the users while also maintaining that the metrics 134 are consistent and comparable. Moreover, in doing so the analysis models 132 may not require retraining for every different privacy setting of the signals 122. Yet further, the analysis models 132 may, in some implementations, be aware of the differential settings 125, to be made aware of which signals 122 are masked.

At operation 606, the cloud server 120 sends the metrics 134 to the metric server 140. In an example, the one or more metric servers 140 may be configured to perform client queries 142 for the metrics 134 for various information, e.g., for preparation of insurance quotes for the vehicles 102 and/or for scheduling maintenance of the vehicles 102.

At operation 608, the cloud server 120 determines whether to update the signals 122. For instance, based on the trends, anomalies, or changes in distribution of the data for the collected signals 122, the cloud server 120 may adjust its data gathering strategies. This may include, for example, updating the sparse signals 128 that are to be received for use by the analysis models 132. This updated approach may enhance future cycles of data collection, leading to more accurate and reliable analysis of the signals 122.

As one example, the cloud server 120 may determine that one or more sparse signals 128 are not relevant to the computation of results from the analysis model 132 or analysis models 132 being used by the user. This may be accomplished, in one example, by providing the sparse signals 128 to the analysis models 132 with a leave-one-out strategy and identifying the result in the metrics 134. If the metrics 134 are the same with or without the sparse signal(s) 128 that are left out of the input, then that left out sparse signal(s) 128 may be less relevant. If, however, the metrics 134 differ, then those sparse signal(s) 128 may be more relevant. Based on such an analysis, the cloud server 120 may recommend signals 122 that are less relevant and may propose removing those signals 122 from the signal controls 404.

Also based on such an analysis, the cloud server 120 may suggest that certain sparse signals 128 that are not being sent for some users should be used to increase accuracy of the metrics 134. In such a case, the cloud server 120 may recommend that the user add certain sparse signals 128 that are presently disabled in the HMI 302.

At operation 610, the cloud server 120 updates the HMI 302. For example, the recommendations determined at operation 608 may be provided to the HMI 302 as a signal update 308. Additionally, a message may be sent to the user (e.g., to the user's mobile device, as an email, to the vehicle 102 for display to the user, etc.) to inform the user that there are potential updates to the differential settings 125 to consider.

At operation 612, the cloud server 120 updates the differential settings 125 of the vehicles 102. For example, the user may update the differential setting 125 using the HMI 302 as discussed above with respect to operation 504. These updated differential settings 125 may be received to the cloud server 120. After operation 612, the process 600 returns to operation 602.

Variations of the process may be possible. For example, dimensionality reduction and feature engineering techniques such as manifold learning may produce varying latent dimensionality using features that are not of great interest to an engineer. In some examples, the disclosed approach may be used to provide feature engineering and dimensionality reduction in a repeatable manner.

In another example, the differential setting 125 may be used for data collection for other scenarios. As a possibility, a data collection may be performed for ADAS event data. This event data may be analyzed to improve ADAS performance, such as for edge cases for which little data is available. In such a situation, users may allow the data collection as long as certain signals are masked (e.g., no eyes on road signal but other signals are allowed to be collected). This approach may allow for a fine-tuned privacy policy for vehicle 102 data collection, rather than a binary all-or-nothing approach.

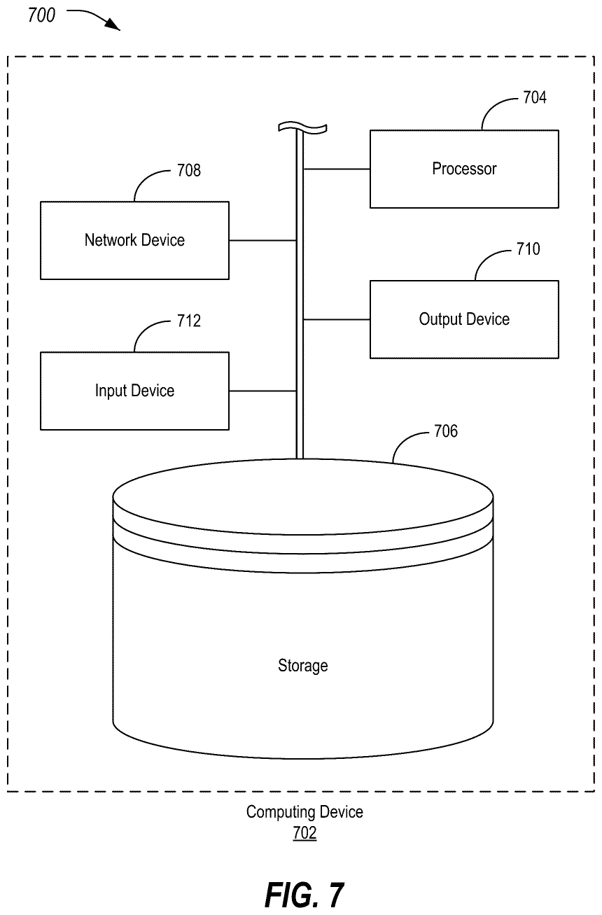

FIG. 7 illustrates an example computing device 702 for using sparse signals 128 for determining vehicle metrics 134. Referring to FIG. 7, and with reference to FIGS. 1-6, the vehicle 102, controllers 104, sensors 106, TCU 110, and cloud server 120 may be examples of such computing devices 702. Computing devices 702 generally include computer-executable instructions, such as those of the vehicle data service 136 and the event processing application 138, where the instructions may be executable by one or more computing devices 702. Computer-executable instructions may be compiled or interpreted from computer programs created using a variety of programming languages and/or technologies, including, without limitation, and either alone or in combination, Java™, C, C++, C #, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data, such as signals 122, encoders 124, differential settings 125, decoders 126, sparse signals 128, settings-preserved signals 130, analysis model 132, metrics 134, etc., may be stored and transmitted using a variety of computer-readable media.

As shown, the computing device 702 may include a processor 704 that is operatively connected to a storage 706, a network device 708, an output device 710, and an input device 712. It should be noted that this is merely an example, and computing devices 702 with more, fewer, or different components may be used.

The processor 704 may include one or more integrated circuits that implement the functionality of a central processing unit (CPU) and/or graphics processing unit (GPU). In some examples, the processors 704 are a system on a chip (SoC) that integrates the functionality of the CPU and GPU. The SoC may optionally include other components such as, for example, the storage 706 and the network device 708 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 704 executes stored program instructions that are retrieved from the storage 706. The stored program instructions, accordingly, include software that controls the operation of the processors 704 to perform the operations described herein. The storage 706 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the system 100.

The GPU may include hardware and software for display of at least two-dimensional (2D) and optionally three-dimensional (3D) graphics to the output device 710. The output device 710 may include a graphical or visual display device, such as an electronic display screen, projector, printer, or any other suitable device that reproduces a graphical display. As another example, the output device 710 may include an audio device, such as a loudspeaker or headphone. As yet a further example, the output device 710 may include a tactile device, such as a mechanically raiseable device that may, in an example, be configured to display braille or another physical output that may be touched to provide information to a user.

The input device 712 may include any of various devices that enable the computing device 702 to receive control input from users. Examples of suitable input devices 712 that receive human interface inputs may include keyboards, mice, trackballs, touchscreens, microphones, graphics tablets, and the like.

The network devices 708 may each include any of various devices that enable the described components to send and/or receive data from external devices over networks. Examples of suitable network devices 708 include an Ethernet interface, a Wi-Fi transceiver, a cellular transceiver, or a BLUETOOTH or BLUETOOTH Low Energy (BLE) transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments may occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method for collecting and processing vehicle data with differential privacy, comprising:
receiving, by a controller of a vehicle, a set of differential privacy settings corresponding to a user of the vehicle, the differential privacy settings defining which sets of one or more vehicle signals to be sent to a cloud server;
capturing, by the controller, a plurality of vehicle signals from a plurality of controllers and/or sensors of the vehicle;
applying, by the controller, a filter to the vehicle signals according to the differential privacy settings to generate filtered signals;
encoding the filtered signals into sparse signals; and
transmitting the sparse signals from the vehicle to the cloud server for processing by an analysis model to determine metrics for the vehicle according to the differential privacy settings of the user.

2. The method of claim 1, wherein the encoding of the filtered signals into the sparse signals includes using a latent space model including an encoder and a decoder, such that the encoding of the filtered signals into the sparse signals is performed using the encoder as installed on the vehicle.

3. The method of claim 1, wherein encoding the filtered signals into the sparse signals includes performing principal component analysis to reduce dimensionality of the filtered signals by finding a subset of orthogonal components that capture variance in the filtered signals.

4. The method of claim 1, further comprising:
detecting presence of the user using the sensors of the vehicle; and
filtering the vehicle signals according to the differential privacy settings corresponding to the user whose presence is detected.

5. The method of claim 1, wherein the differential privacy settings include parameters for noise addition, and the filter adds noise to the vehicle signals before encoding to enhance user privacy.

6. The method of claim 5, wherein the noise added by the filter is Gaussian noise, Laplace noise, or reduction in fidelity of the vehicle signals, and the amount of the noise is adjustable based on the differential privacy settings.

7. The method of claim 1, further comprising:
displaying, on a human-machine interface (HMI), a set of user-selectable signal controls, each control corresponding to a different set of the one or more vehicle signals; and
updating the differential privacy settings based on selection received from the user of which of the sets of the one or more vehicle signals to share with the cloud server.

8. The method of claim 7, further comprising providing, on the HMI, an indication of which of the sets of the one or more vehicle signals correlate with the metrics generated by the analysis model to assist the user in selecting the one or more vehicle signals to share.

9. The method of claim 7, further comprising:
receiving a message indicating a request to update the set of user-selectable signal controls based on an analysis by the cloud server of contributions of the sets of the one or more vehicle signals to the metrics.

10. The method of claim 1, wherein the analysis model determines the metrics with respect to vehicle maintenance.

11. The method of claim 1, wherein the analysis model determines the metrics with respect to usage-based insurance.

12. A system for using universal signals for determining vehicle metrics, comprising:
one or more computing devices of a cloud server including non-transitory storage and a processor, configured to:
receive, from a plurality of vehicles, sparse signals corresponding to vehicle data captured by sensors and/or controllers of the vehicles, the sparse signals being filtered according to differential privacy settings defining which sets of one or more vehicle signals to be sent to the cloud server;
apply, by the cloud server, an analysis model to the sparse signals to generate vehicle metrics;
analyze the vehicle metrics for contributions of the sets of one or more vehicle signals to the metrics; and
send messages, to the vehicles, to update the sets of the one or more vehicle signals based on an analysis by the cloud server of contributions of the sets of the one or more vehicle signals to the metrics.

13. The system of claim 12, wherein the one or more computing devices are further configured to transmit, in response to client queries, the generated vehicle metrics to a metric server for access by insurance providers or vehicle service entities.

14. The system of claim 12, wherein the one or more computing devices are further configured to:
provide, on a HMI, a set of user-selectable signal controls, each control corresponding to a different set of the one or more vehicle signals; and
update the differential privacy settings for a user based on selection received from the user of which of the sets of the one or more vehicle signals to share with the cloud server.

15. The system of claim 14, wherein the one or more computing devices are further configured to:
provide, on the HMI, an indication of which of the sets of the one or more vehicle signals correlate with the metrics generated by the analysis model to assist the user in selecting the one or more vehicle signals to share.

16. The system of claim 12, wherein the sparse signals are encoded, using a latent space model including an encoder and a decoder, by the encoder, and the one or more computing devices are further configured to apply the sparse signals to the analysis model without decoding the sparse signals using the decoder.

17. The system of claim 12, wherein the sparse signals are encoded by performing principal component analysis to reduce dimensionality of the vehicle data by finding a subset of orthogonal components that capture variance in the vehicle data.

18. A vehicle for collecting and processing vehicle data with differential privacy, comprising:
one or more sensors and/or controllers; and
a processing controller, in communication with the one or more sensors and/or controllers, configured to:
receive a set of differential privacy settings corresponding to a user of the vehicle, the differential privacy settings defining which sets of one or more vehicle signals to be sent to a cloud server,
capture a plurality of vehicle signals from the one or more sensors and/or controllers,
detect presence of the user using the one or more sensors and/or controllers,
apply a filter to the vehicle signals, according to the differential privacy settings corresponding to the user whose presence is detected, to generate filtered signals,
encode, using a latent space model including an encoder and a decoder, by the encoder as installed on the vehicle, the filtered signals into sparse signals, and
transmit the sparse signals from the vehicle to the cloud server for processing by an analysis model to determine metrics for the vehicle according to the differential privacy settings of the user.

19. The vehicle of claim 18, wherein the differential privacy settings include parameters for noise addition, and the filter adds noise to the vehicle signals before encoding to enhance user privacy.

20. The vehicle of claim 19, wherein the noise added by the filter is Gaussian noise, Laplace noise, or reduction in fidelity of the vehicle signals, and the amount of the noise is adjustable based on the differential privacy settings.

21. The vehicle of claim 18, wherein the processing controller is further configured to:
display, on an HMI, a set of user-selectable signal controls, each control corresponding to a different set of the one or more vehicle signals; and
update the differential privacy settings based on selection received from the user of which of the sets of the one or more vehicle signals to share with the cloud server.

22. The vehicle of claim 21, wherein the processing controller is further configured to provide, on the HMI, an indication of which of the sets of the one or more vehicle signals correlate with the metrics generated by the analysis model to assist the user in selecting the one or more vehicle signals to share.

23. The vehicle of claim 21, wherein the processing controller is further configured to receive a message indicating a request to update the set of user-selectable signal controls based on an analysis by the cloud server of contributions of the sets of the one or more vehicle signals to the metrics.
